(19) United States
(12) Patent Application Publication
(10) Pub. No.: US 2018/0071928 A1
(43) Pub. Date: Mar. 15, 2018

(54) Hair Trimming Device

(71) Applicant: Joao Rodrigues, Houston, TX (US)

(72) Inventor: Joao Rodrigues, Houston, TX (US)

(21) Appl. No.: 15/266,089

(22) Filed: Sep. 15, 2016

(51) Int. Cl. B26B 19/38; B26B 19/20; A45F 5/02

(52) U.S. Cl. CPC B26B 19/3853; B26B 19/20; A45F 5/022; B26B 19/3833; B26B 19/382

(57) ABSTRACT

A hair trimming device for trimming hair in designs includes a first housing that defines an internal space. The first housing has an upper end. The upper end is open. A power module is coupled to the first housing and is positioned in the internal space. A blade assembly is slidably coupled to the first housing. The blade assembly is selectively extensible from the internal space through the upper end. The blade assembly is operationally coupled to the power module. The blade assembly is positioned in the first housing such that the blade assembly is extensible from the first housing. The blade assembly is coupled to the power module such that the blade assembly is configured to sever hairs of a user.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art including information disclosed under 37 CFR 1.97 and 1.98

The disclosure and prior art relates to trimming devices and more particularly pertains to a new trimming device for trimming hair in designs.

### (h) BRIEF SUMMARY OF THE INVENTION

An embodiment of the disclosure meets the needs presented above by generally comprising a first housing that defines an internal space. The first housing has an upper end. The upper end is open. A power module is coupled to the first housing and is positioned in the internal space. A blade assembly is slidably coupled to the first housing. The blade assembly is selectively extensible from the internal space through the upper end. The blade assembly is operationally coupled to the power module. The blade assembly is positioned in the first housing such that the blade assembly is extensible from the first housing. The blade assembly is coupled to the power module such that the blade assembly is configured to sever hairs of a user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a hair trimming device according to an embodiment of the disclosure.

FIG. 2 is an isometric perspective view of an embodiment of the disclosure.

FIG. 3 is an isometric perspective view of an embodiment of the disclosure.

FIG. 4 is a cross-sectional view of an embodiment of the disclosure.

FIG. 5 is a cross-sectional view of an embodiment of the disclosure.

### (j) DETAILED DESCRIPTION OF THE INVENTION

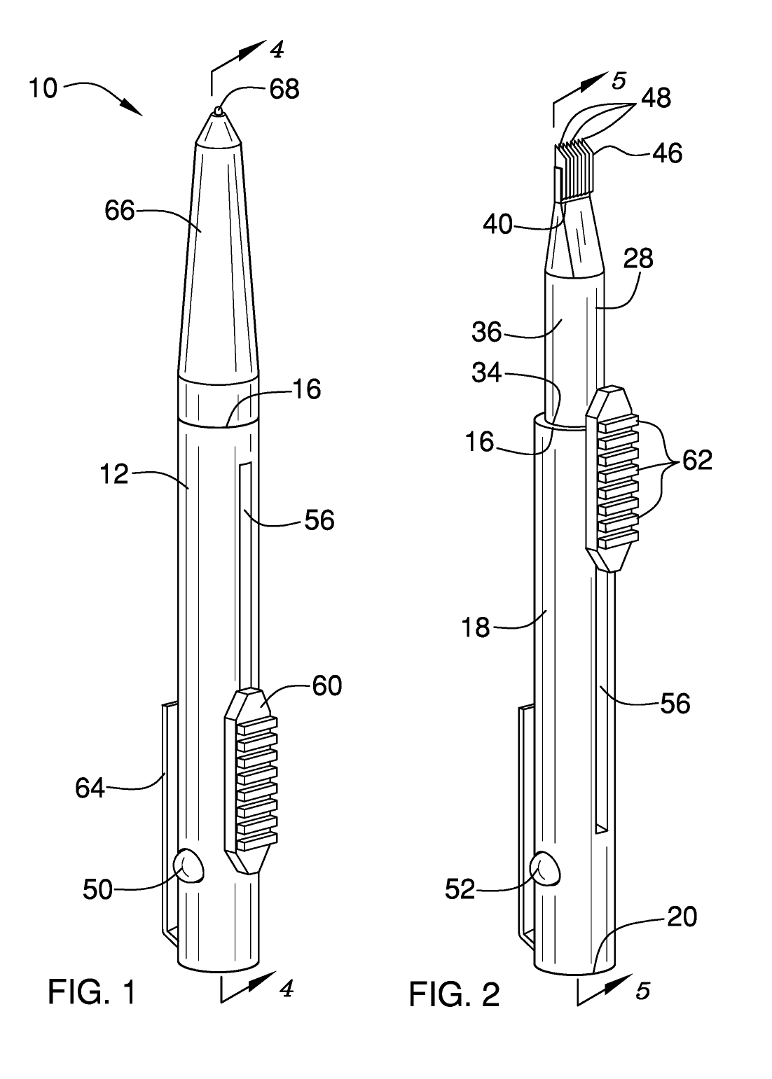

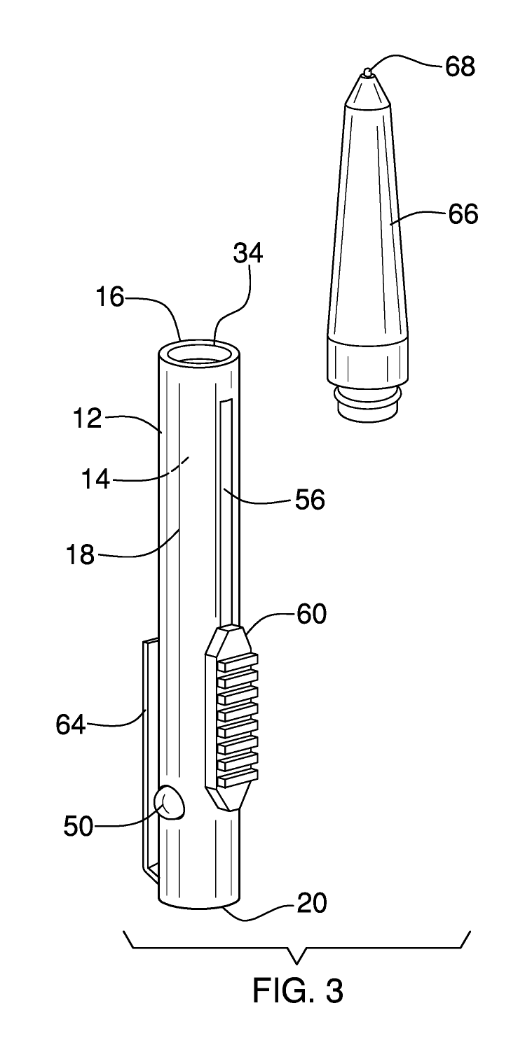

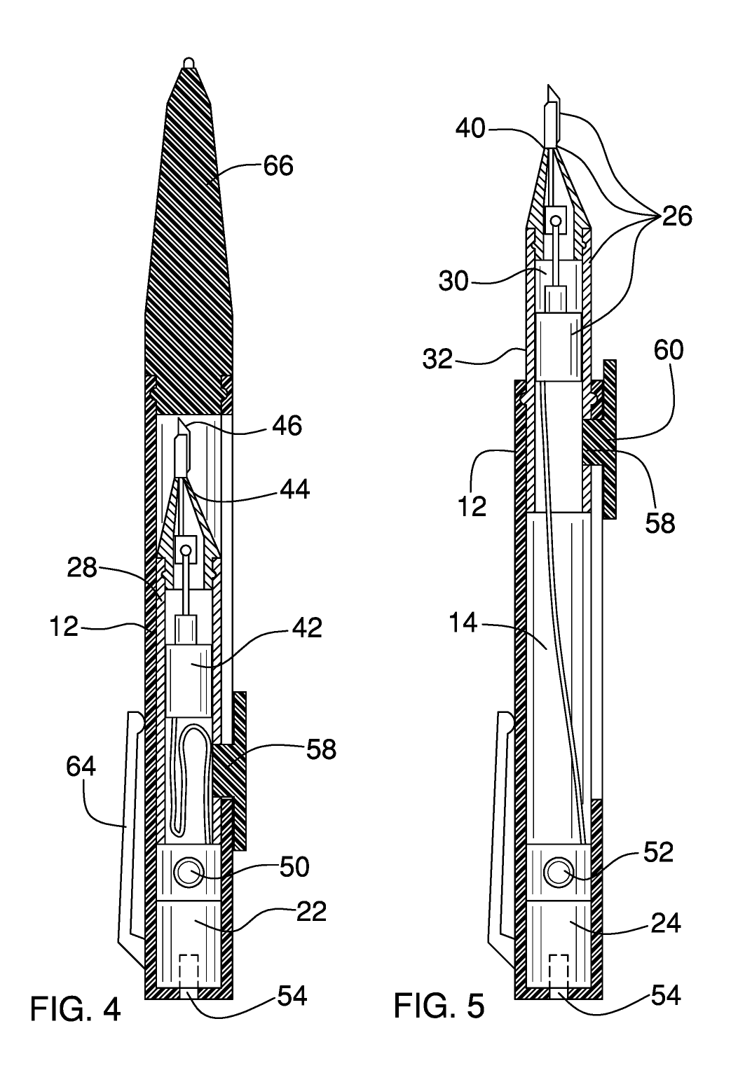

With reference now to the drawings, and in particular to FIGS. 1 through 5 thereof, a new trimming device embodying the principles and concepts of an embodiment of the disclosure and generally designated by the reference numeral 10 will be described.

As best illustrated in FIGS. 1 through 5, the hair trimming device 10 generally comprises a first housing 12 that defines an internal space 14. The first housing 12 has an upper end 16. The upper end 16 is open. The first housing 12 comprises an annular wall 18 that extends from the upper end 16 to a lower end 20. In one embodiment, the upper end 16 and the lower end 20 are substantially circularly shaped, such that the first housing 12 is cylindrically shaped.

A power module 22 is coupled to the first housing 12 and is positioned in the internal space 14. In one embodiment, the power module 22 comprises at least one battery 24. In another embodiment, the at least one battery 24 is rechargeable.

A blade assembly 26 is slidably coupled to the first housing 12. The blade assembly 26 is selectively extensible from the internal space 14 through the upper end 16. The blade assembly 26 is operationally coupled to the power module 22. The blade assembly 26 is positioned in the first housing 12 such that the blade assembly 26 is extensible from the first housing 12. The blade assembly 26 is coupled to the power module 22 such that the blade assembly 26 is configured to sever hairs of a user.

The blade assembly 26 comprises a second housing 28 that defines an interior space 30. The second housing 28 has an outer perimeter 32 that is complementary to an inner perimeter 34 the first housing 12, such that the second housing 28 is insertable into the internal space 14. The second housing 28 comprises an annular sidewall 36 that extends from a bottom 38 to a top 40. The annular sidewall 36 is tapered, such that the top 40 is substantially rectangularly shaped.

A motor 42 is coupled to the second housing 28 and is positioned in the interior space 30. The motor 42 is operationally coupled to the power module 22.

A cutter 44 is positioned in the second housing 28 adjacent to the top 40. The cutter 44 is operationally coupled to the motor 42. The cutter 44 is coupled to the motor 42 such that the motor 42 is positioned to induce movement of the cutter 44.

A comb 46 is coupled to the top 40 of the second housing 28. The comb 46 comprises a plurality of tines 48. The comb 46 is positioned on the second housing 28 such that the comb 46 is configured to guide hairs to a position adjacent to the cutter 44 so that the hairs are severed by movement of the cutter 44.

A switch 50 is coupled to the first housing 12. The switch 50 is operationally coupled to the power module 22 and the motor 42. The switch 50 is positioned to enable the user to selectively couple the motor 42 to the power module 22. In one embodiment, the switch 50 comprises a power button 52. The power button 52 is selectively depressible.

A port 54 is positioned in the lower end 20 of the first housing 12. The port 54 is configured to couple the power module 22 to a source of electric current. The port 54 is positioned in the first housing 12 such that the port 54 is configured to couple the power module 22 to the source of electric current to recharge the power module 22.

A channel 56 is positioned longitudinally through the annular wall 18. The channel 56 extends from proximate to the upper end 16 toward the lower end 20 of the first housing 12. A tab 58 is coupled to the second housing 28 and extends through the channel 56. A slide 60 is coupled to the tab 58 distal from the second housing 28, such that the slide 60 is positioned outside of the first housing 12. The slide 60 is configured to enable the user to selectively motivate the second housing 28 relative to the first housing 12.

In one embodiment, a plurality of protrusions 62 is coupled to the slide 60. The protrusions 62 are positioned on the slide 60 such that the protrusions 62 are configured to deter slippage of a digit of the hand of the user as the user motivates the second housing 28 relative to the first housing 12.

A clip 64 is coupled to the first housing 12 proximate to the lower end 20. The clip 64 is positioned on the first housing 12 such that the clip 64 is configured to couple the first housing 12 to an object of the user, such as a pocket of a garment of the user.

In one embodiment, the device 10 comprises a cap 66 that is complementary to the upper end 16 of the first housing 12. The cap 66 is reversibly couplable to the first housing 12. The cap 66 is tapered and comprises a pointed end 68, such that the cap 66 resembles a pen tip. The cap 66 and the first housing 12 resemble a pen when the cap 66 is coupled to the first housing 12.

In use, the slide 60 is configured to enable the user to selectively motivate the second housing 28 relative to the first housing 12 such that the blade assembly 26 is extensible from the first housing 12. The comb 46 is positioned on the second housing 28 such that the comb 46 is configured to guide hairs to a position adjacent to the cutter 44. The cutter 44 is coupled to the motor 42 such that the motor 42 is positioned to induce movement of the cutter 44 to sever hairs of a user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hair trimming device comprising:
a first housing defining an internal space, said first housing having an upper end, said upper end being open;
a power module coupled to said first housing and positioned in said internal space;
a blade assembly slidably coupled to said first housing, such that said blade assembly is selectively extensible from said internal space through said upper end, said blade assembly being operationally coupled to said power module; and
wherein said blade assembly is positioned in said first housing such that said blade assembly is extensible from said first housing, wherein said blade assembly is coupled to said power module such that said blade assembly is configured for severing hairs of a user.

2. The device of claim 1, further including said power module comprising at least one battery.

3. The device of claim 2, further including said at least one battery being rechargeable.

4. The device of claim 1, further including said blade assembly comprising:
a second housing defining an interior space, said second housing having an outer perimeter complementary to an inner perimeter of said first housing, such that said second housing is insertable into said internal space, said second housing comprising an annular sidewall extending from a bottom to a top, said annular sidewall being tapered, such that said top is substantially rectangularly shaped;
a motor coupled to said second housing and positioned in said interior space, said motor being operationally coupled to said power module;
a cutter positioned in said second housing adjacent to said top, said cutter being operationally coupled to said motor, wherein said cutter is coupled to said motor such that said motor is positioned to induce movement of said cutter;
a comb coupled to said top of said second housing, said comb comprising a plurality of tines; and
wherein said comb is positioned on said second housing such that said comb is configured to guide hairs to a position adjacent to said cutter, such that the hairs are severed by movement of said cutter.

5. The device of claim 4, further including a switch coupled to said first housing, said switch being operationally coupled to said power module and said motor, wherein said switch is positioned to enable the user to selectively couple said motor to said power module.

6. The device of claim 5, further including said switch comprising a power button, said power button being selectively depressible.

7. The device of claim 1, further including a port positioned in a lower end of said first housing, said port being configured for coupling of said power module to a source of electric current, wherein said port is positioned in said first housing such that said port is configured to couple said power module to the source of electric current, such that said power module is recharged.

8. The device of claim 4, further comprising;
said first housing comprising an annular wall extending from said upper end to a lower end;
a channel positioned longitudinally through said annular wall, said channel extending from proximate to said upper end toward said lower end of said first housing;
a tab coupled to said second housing, said tab extending through said channel;
a slide coupled to said tab distal from said second housing, such that said slide is positioned outside of said first housing; and
wherein said slide is configured to enable the user to selectively motivate said second housing relative to said first housing.

9. The device of claim 8, further including a plurality of protrusions coupled to said slide, wherein said protrusions are positioned on said slide such that said protrusions are configured to deter slippage of a digit of the hand of the user as the user motivates said second housing relative to said first housing.

10. The device of claim 1, further including a clip coupled to said first housing proximate to a lower end of said first housing, wherein said clip is positioned on said first housing such that said clip is configured for coupling of said first housing to an object of the user, such as a pocket of a garment of the user.

11. The device of claim 8, further including said upper end and said lower end being substantially circularly shaped, such that said first housing is cylindrically shaped.

12. The device of claim 11, further including a cap complementary to said upper end of said first housing, said cap being reversibly couplable to said first housing, said cap being tapered, said cap comprising a pointed end, such that said cap resembles a pen tip and such that said cap and said first housing resemble a pen when said cap is coupled to said first housing.

13. A hair trimming device comprising:
a first housing defining an internal space, said first housing having an upper end, said upper end being open, said first housing comprising an annular wall extending from said upper end to a lower end, said upper end and said lower end being substantially circularly shaped, such that said first housing is cylindrically shaped;
a power module coupled to said first housing and positioned in said internal space, said power module comprising at least one battery, said at least one battery being rechargeable;
a blade assembly slidably coupled to said first housing, such that said blade assembly is selectively extensible from said internal space through said upper end, said blade assembly being operationally coupled to said power module, wherein said blade assembly is positioned in said first housing such that said blade assembly is extensible from said first housing, wherein said blade assembly is coupled to said power module such that said blade assembly is configured for severing hairs of a user, said blade assembly comprising:
a second housing defining an interior space, said second housing having an outer perimeter complementary to an inner perimeter of said first housing, such that said second housing is insertable into said internal space, said second housing comprising an annular sidewall extending from a bottom to a top, said annular sidewall being tapered, such that said top is substantially rectangularly shaped,
a motor coupled to said second housing and positioned in said interior space, said motor being operationally coupled to said power module,
a cutter positioned in said second housing adjacent to said top, said cutter being operationally coupled to said motor, wherein said cutter is coupled to said motor such that said motor is positioned to induce movement of said cutter,
a comb coupled to said top of said second housing, said comb comprising a plurality of tines, and
wherein said comb is positioned on said second housing such that said comb is configured to guide hairs to a position adjacent to said cutter, such that the hairs are severed by movement of said cutter;
a switch coupled to said first housing, said switch being operationally coupled to said power module and said motor, wherein said switch is positioned to enable the user to selectively couple said motor to said power module, said switch comprising a power button, said power button being selectively depressible;
a port positioned in said lower end of said first housing, said port being configured for coupling of said power module to a source of electric current, wherein said port is positioned in said first housing such that said port is configured to couple said power module to the source of electric current, such that said power module is recharged;
a channel positioned longitudinally through said annular wall, said channel extending from proximate to said upper end toward said lower end of said first housing;
a tab coupled to said second housing, said tab extending through said channel;
a slide coupled to said tab distal from said second housing, such that said slide is positioned outside of said first housing, wherein said slide is configured to enable the user to selectively motivate said second housing relative to said first housing;
a plurality of protrusions coupled to said slide, wherein said protrusions are positioned on said slide such that said protrusions are configured to deter slippage of a digit of the hand of the user as the user motivates said second housing relative to said first housing;
a clip coupled to said first housing proximate to said lower end, wherein said clip is positioned on said first housing such that said clip is configured for coupling of said first housing to an object of the user, such as a pocket of a garment of the user;
a cap complementary to said upper end of said first housing, said cap being reversibly couplable to said first housing, said cap being tapered, said cap comprising a pointed end, such that said cap resembles a pen tip and such that said cap and said first housing resemble a pen when said cap is coupled to said first housing; and
wherein said slide is configured to enable the user to selectively motivate said second housing relative to said first housing such that said blade assembly is extensible from said first housing, wherein said comb is positioned on said second housing such that said comb is configured to guide hairs to a position adjacent to said cutter, wherein said cutter is coupled to said motor such that said motor is positioned to induce movement of said cutter to sever hairs of a user.
